(19) United States
(12) Patent Application Publication
(10) Pub. No.: US 2026/0075608 A1
(43) Pub. Date: Mar. 12, 2026

(54) SYSTEM AND METHOD FOR DELAY-RELIABILITY AWARE DOWNLINK SCHEDULING IN 5G NR FOR EXTENDED REALITY (XR) SERVICES USING DELAY TRACKING MECHANISM.

(71) Applicant: INDIAN INSTITUTE OF TECHNOLOGY KHARAGPUR, Kharagpur (IN)

(72) Inventors: Moyukh Laha, Kharagpur (IN); Goutam Das, Kharagpur (IN)

(73) Assignee: INDIAN INSTITUTE OF TECHNOLOGY KHARAGPUR, Kharagpur (IN)

(21) Appl. No.: 19/022,903

(22) Filed: Jan. 15, 2025

(30) Foreign Application Priority Data
Sep. 9, 2024 (IN) 202431068059

(51) Int. Cl. H04W 72/1273; H04W 28/06; H04W 72/543

(52) U.S. Cl. CPC H04W 72/1273; H04W 28/06; H04W 72/543

(57) ABSTRACT

This invention discloses a novel downlink scheduling scheme to maximize the number of XR users who meet their strict delay reliability requirements in 5G networks. Each XR user is assigned a predefined delay bound, within which Data Units (DUs)—encompassing packets, frames, or Service Data Units (SDUs)—must be transmitted. Failure to transmit within this bound results in a delay violation, which can degrade the user's experience. Additionally, each user has a specified reliability threshold, denoted as X %, indicating the minimum percentage of DUs that must be successfully delivered within the delay bound to meet the user's quality expectations. The proposed scheduling scheme ensures that the highest possible number of XR users achieve their required delay reliability. To accomplish this, the scheme integrates two critical components: (a) a delay tracking mechanism, and (b) a downlink scheduling strategy that optimizes scheduling based on real-time delay information.

### RELATED APPLICATIONS

This application claims priority to India Patent Application No. 202431068059, Filing Date Sep. 9, 2024, entitled SYSTEM AND METHOD FOR DELAY-RELIABILITY AWARE DOWNLINK SCHEDULING IN 5G NR FOR EXTENDED REALITY (XR) SERVICES USING DELAY TRACKING MECHANISM.; which is incorporated herein by reference in its entirety.

### FIELD OF THE INVENTION

This invention introduces a novel downlink scheduling scheme for 5G networks. More specifically, the present invention is directed to provide a system and a method for delay reliability aware downlink scheduling in 5G NR for extended reality-based communication services by involving Delay Tracking Queues (DTQs) to manage and prioritize data units based on their remaining time to deadline. It integrates Model Predictive Control (MPC) for dynamic resource allocation and adaptive priority computation, ensuring efficient use of network resources. These innovations enable real-time adjustments to changing network conditions, significantly improving delay reliability and overall network performance for XR applications in 5G NR.

### BACKGROUND OF THE INVENTION

The evolution of 5G downlink scheduling has seen the emergence of various strategies aimed at addressing the complex demands of modern wireless networks. These strategies predominantly focus on optimizing resource allocation, maintaining quality of service (QoS), and maximizing throughput across diverse network conditions.

In recent years, machine learning techniques, particularly Deep Reinforcement Learning (DRL), have gained prominence in the development of 5G scheduling schemes. Techniques such as Deep Q-Network (DQN) and Recurrent Proximal Policy Optimization (RPPO) have been utilized to optimize modulation and coding schemes (MCS) and space division multiplexing (SDM). These methods also enable delay-oriented packet scheduling in scenarios characterized by limited channel state information (CSI) [1][3][8].

To address heterogeneous traffic requirements, the Enhanced Joint Scheduling (eJS) scheme has been proposed, focusing on balancing the demands of guaranteed bit rate (GBR) and non-GBR services. This approach ensures minimum data rate requirements while simultaneously optimizing system throughput and fairness [2]. In time-sensitive communications (TSC), scheduling strategies are designed to leverage traffic pattern knowledge to meet stringent latency and reliability requirements, evaluating the effectiveness of semi-persistent and dynamic packet scheduling methods [4].

Cross-layer scheduling and resource allocation (SRA) techniques have been developed to integrate both channel and queue states, thereby supporting fairness. These techniques also incorporate advanced modulation methods such as filter-bank multicarrier/offset quadrature amplitude modulation (FBMC/OQAM) to enhance spectral efficiency [5]. For enhanced Mobile Broadband (eMBB) applications, lean schedulers that combine the best Channel Quality Indicator (CQI) with proportional fair (PF) schemes have been engineered to optimize throughput and fairness, especially for users at the cell edge [6].

The coexistence of URLLC and eMBB traffic has led to the development of dynamic scheduling methods that utilize techniques like puncturing. These methods are designed to meet URLLC's stringent latency requirements while protecting eMBB users'bandwidth needs [7]. In OFDMA-based systems, commonly used scheduling schemes include round-robin (RR), maximum rate (MR), and proportional fair (PF), with optimized PF schedulers proposed to enhance throughput and fairness, particularly in scenarios with higher numerology [9].

Flexible channel-dependent scheduling methods, such as the alpha-rule scheme, allow for adjustable trade-offs between aggregate throughput, per-user throughput, and resource allocation. By adjusting a single control parameter, these methods effectively balance multiuser diversity gain and location-specific performance [10].

However, despite the advancements in existing scheduling schemes, they are primarily designed to support either eMBB or URLLC applications. These schemes do not sufficiently address the unique challenges posed by XR applications, which require ultra-low latency, high reliability, high data rate, and dynamic resource allocation. The current scheduling mechanisms lack the flexibility, granularity, and context-awareness necessary to meet the evolving demands of XR services, highlighting the need for innovative solutions in this area.

### REFERENCES

[1] Y. Liao, Z. Yang, Z. Yin, and X. Shen, “DQN-Based Adaptive MCS and SDM for 5G Massive MIMO-OFDM Downlink,” IEEE Communications Letters, vol. 27, pp. 185-189, 2023.
[2] D. Panno and S. Riolo, “An enhanced joint scheduling scheme for GBR and non-GBR services in 5G RAN,”Wireless Networks, vol. 26, pp. 3033-3052, 2020.
[3] Y. Hao, F. Li, C. Zhao, and S. Yang, “Delay-Oriented Scheduling in 5G Downlink Wireless Networks Based on Reinforcement Learning with Partial Observations,” IEEE/ACM Transactions on Networking, vol. 31, pp. 380-394, 2023.
[4] R. B. Abreu et al., “Scheduling Enhancements and Performance Evaluation of Downlink 5G Time-Sensitive Communications,” IEEE Access, vol. 8, pp. 128106-128115, 2020.
[5] A. Vora and K. Kang, “Downlink Scheduling and Resource Allocation for 5G MIMO Multicarrier Systems,” 2018 IEEE 5G World Forum (5GWF), pp. 174-179, 2018.
[6] M. Sağlam and M. Kartal, “5G Enhanced Mobile Broadband Downlink Scheduler,” 2019 11th International Conference on Electrical and Electronics Engineering (ELECO), pp. 687-692, 2019.
[7] S. R. Pandey, M. Alsenwi, Y. Tun, and C. Hong, “A Downlink Resource Scheduling Strategy for URLLC Traffic,” 2019 IEEE International Conference on Big Data and Smart Computing (BigComp), pp. 1-6, 2019.
[8] M. Seguin et al., “Deep Reinforcement Learning for Downlink Scheduling in 5G and Beyond Networks: A Review,” 2023 IEEE 34th Annual International Symposium on Personal, Indoor and Mobile Radio Communications (PIMRC), pp. 1-6, 2023.
[9] H. I. Fitriasari, A. I. Lestari, D. L. Luhurkinanti, and R. F. Sari, “Performance Evaluation of Downlink Multi-user OFDMA Scheduling in 5G New Radio (NR),” 2021 18th International Conference on Electrical Engineering/Electronics, Computer, Telecommunications and Information Technology (ECTI-CON), pp. 219-223, 2021.
[10] A. Sang, X. Wang, M. Madihian, and R. Gitlin, “A flexible downlink scheduling scheme in cellular packet data systems,” IEEE Transactions on Wireless Communications, vol. 5, pp. 568-577, 2006.

### OBJECT OF THE INVENTION

It is thus the basic object of the present invention is to develop a system and a method for delay reliability aware downlink scheduling in 5G NR for extended reality-based communication services which will address the limitations of the current scheduling mechanisms.

Another object of the present invention is to develop a system and a method for delay reliability aware downlink scheduling in 5G NR which will effectively involve Delay Tracking Queues (DTQs) to manage and prioritize data units based on their remaining time to deadline.

Another object of the present invention is to develop a system and a method for delay reliability aware downlink scheduling in 5G NR which will be enabled for systematic shifting of unscheduled data units between DTQs to maintain accurate delay tracking and minimize delay violations.

Yet another object of the present invention is to develop a system and a method for delay reliability aware downlink scheduling in 5G NR which will solve the resource allocation optimization problem of DL scheduling, targeting the satisfaction of delay reliability requirements for XR (Extended Reality) users.

Yet another object of the present invention is to develop a system and a method for delay reliability aware downlink scheduling in 5G NR which will implementation of an adaptive priority computation that dynamically adjusts user priorities based on their delay reliability performance.

### SUMMARY OF THE INVENTION

Thus, according to the basic aspect of the present invention there is provided a method for optimizing downlink scheduling in a 5G network to maximize number of XR users meeting their delay reliability requirements, comprising:
involving a number of XR user and assigning each of the XR users a predefined delay bound and a specified reliability threshold indicating minimum percentage of Service Data Units (SDUs) that must be successfully delivered within the delay bound;
implementing delay tracking to ensure that only the SDUs within their allowable delay bounds are retained and scheduled for transmission, maintaining the integrity of the delay tracking process;
employing a Model Predictive Control (MPC) approach to optimize resource allocation, forecasting future resource requirements and accordingly dynamically adjusting the scheduling decisions to maximize the number of the involved XR meeting their delay reliability requirements.

In the above method, the delay tracking includes

Delay Tracking Queues (DTQs) whereby the SDUs stored in MAC queues are reorganized and allocated into the DTQs, where each DTQ, designated as ‘DTQ x’, holds the SDUs whose Packet Data Convergence Protocol (PDCP) discard timers are set to expire within ‘x’ units of time such as that the SDUs in the DTQ x are scheduled for transmission within ‘x’ time units to avoid a delay violation; and Delay Tracking Granularity (DTG) corresponds to granularity of the time units which is synchronized with Transmission Time Interval (TTI) duration to ensure precise and consistent tracking of delay across different numerology settings.

In the above method, the delay tracking includes
partially or fully scheduling the SDUs from each of the DTQs during every scheduling instance, whereby if only a portion of the SDUs within a DTQ is scheduled, remaining SDUs PDCP Discard Timer (PDT) are reduced by one-time unit;
shifting the unscheduled SDUs between the DTQs based on updated PDTs;
repeating the shifting process across all the DTQs, ensuring that the SDUs are continually moved to the appropriate DTQ with lower priority based on their updated PDTs;
discarding the SDUs which are remain in same DTQ after a scheduling attempt for having a PDT of zero, signalling a delay violation and failing to meet the delay requirement to ensures that only the SDUs within their allowable delay bounds are retained for transmission, maintaining the integrity of the delay tracking process.

In the above method, the Model Predictive Control (MPC) method predicts future system behaviour using a dynamic model, whereby at each time step, the MPC solves an optimization problem over a finite prediction horizon, generating a sequence of control actions that minimize a cost function while adhering to system constraints focusing on maximizing the number of XR users who meet their delay reliability requirements including
generating the sequence of control action for the scheduling scheme using a prediction horizon (H) to forecast and calculate future resource needs, where system state is represented by the DTQ information, which includes queue sizes and associated PDTs, with system dynamics influenced by new data arrivals, varying channel conditions, and scheduling decisions made at each instance;
wherein at each time step (t), the scheme solves an optimization problem aimed at maximizing the number of users who meet their delay reliability targets while ensuring efficient resource allocation considering constraints: (a) total allocated resources must not exceed the system capacity, (b) scheduling must respect each user's delay bounds as defined by their DTQ states, and (c) scheme strives to satisfy the specified delay reliability percentages for each user.

In the above method, the MPC method includes heuristic method that is applied to solve the optimization at each time instant for resource block (RB) allocation to the users, targeting the efficient satisfaction of delay reliability requirements for XR users for resource allocation in a 5G network to meet XR users'delay reliability requirements, comprising:
receiving the Delay Tracking Queue (DTQ) information representing the current state of the SDUs and their PDCP Discard Timers (PDT);
calculating the resource requirements for each user based on the current DTQ state and predicted traffic arrivals using statistical models;
performing adaptive priority computation to dynamically adjust resource allocation priorities based on the user's delay performance;
allocating resources using a greedy approach that prioritizes tasks with the shortest delay bounds and highest priority, and ensuring no resources are wasted on tasks that cannot meet their delay bound.

In the above method, the future resource requirements are predicted based on statistical models that account for anticipated XR traffic arrivals and network channel conditions over a predefined prediction horizon.

According to another aspect in the present invention there is provided a system for optimizing downlink scheduling in a 5G network to maximize the number of XR users meeting their delay reliability requirements involving the above method comprising:
a processor configured to execute the delay tracking mechanism and scheduling optimization based on delay reliability requirements of XR users;
a memory storing Delay Tracking Queues (DTQs) containing SDUs and associated PDCP Discard Timers (PDT);
a communication module configured to allocate downlink resources to users in real time, based on an optimization strategy that maximizes delay reliability.

The above system further comprising:
a user equipment (UE) configured to receive downlink control information (DCI) and process allocated resource blocks;
a gNB with a server configured to execute the Model Predictive Control (MPC) based optimization for allocating resources to maximize the number of the XR users who meet their delay reliability targets, based on delay tracking and priority computation.

### BRIEF DESCRIPTION OF THE DRAWINGS

FIG. 1: Description of MAC Queue for UEs at gNB

FIG. 2: UE MACQ to DTQ mapping

FIG. 3: Delay tracking mechanism using DTQ

FIG. 4: Flowchart of DL Scheduling for XR in 5G

FIG. 5: Heuristic Method Flowchart

FIG. 6: Performance Comparison of the proposed solution with PF, RR, and MAX-CQI.

FIG. 7: Conceptual representation of the hardware changes in gNB and UE

### DESCRIPTION OF THE INVENTION

This invention introduces a novel downlink scheduling scheme designed to maximize the number of XR users who meet their strict delay reliability requirements in 5G networks. Each XR user is assigned a predefined delay bound, within which Data Units (DUs)—encompassing packets, frames, or Service Data Units (SDUs)—must be transmitted. Failure to transmit within this bound results in a delay violation, which can degrade the user's experience. Additionally, each user has a specified reliability threshold, denoted as X %, indicating the minimum percentage of DUs that must be successfully delivered within the delay bound to meet the user's quality expectations. The primary objective of the proposed scheduling scheme is to ensure that the highest possible number of XR users achieve their required delay reliability. To accomplish this, the scheme integrates two critical components: (a) a delay tracking mechanism, and (b) a downlink scheduling strategy that optimizes scheduling based on real-time delay information.

Before delving into the specifics of the proposed scheduling scheme, it is important to understand the existing 5G downlink scheduling framework from the 5G protocol stack perspective.

The downlink scheduling process in 5G is a multi-layered and complex procedure that begins when IP packets arrive at the gNB from the core network. These packets are first classified based on their Quality of Service Flow Identifier (QFI) and are then converted into Service Data Units (SDUs) at the Packet Data Convergence Protocol (PDCP) layer. To manage latency and prevent buffer overflow, a PDCP Discard Timer (PDT) is initiated for each SDU. If an SDU exceeds its waiting time, it is discarded. Within the PDCP layer, SDUs undergo processes such as header compression, ciphering, and integrity protection before being passed to the Radio Link Control (RLC) layer. The RLC layer further processes these SDUs by segmenting or concatenating them into RLC Protocol Data Units (PDUs), operating in different modes: Acknowledged Mode (AM), Unacknowledged Mode (UM), or Transparent Mode (TM). AM mode, in particular, utilizes an Automatic Repeat Request (ARQ) mechanism to enhance reliability. Subsequently, at the Medium Access Control (MAC) layer, the RLC PDUs are multiplexed into Transport Blocks (TBs), and the MAC layer also manages Hybrid Automatic Repeat Request (HARQ) processes. The MAC layer scheduler is a critical component that makes real-time decisions on resource allocation based on various factors, including buffer status, QoS requirements, channel conditions, and available resources across time, frequency, and spatial domains. These decisions are communicated via Downlink Control Information (DCI), which specifies resource allocation, Modulation and Coding Scheme (MCS), Multiple Input Multiple Output (MIMO) layers, and HARQ information. At the physical layer, Transport Blocks (TBs) are encoded and modulated according to the selected MCS, then mapped to physical resource blocks, and transmitted over the Physical Downlink Shared Channel (PDSCH). Control information is transmitted through the Physical Downlink Control Channel (PDCCH). The User Equipment (UE) decodes the PDCCH to obtain scheduling information, processes the data received on the PDSCH, and sends acknowledgments (ACK/NACK) via the Physical Uplink Control Channel (PUCCH). This feedback loop is essential for enabling HARQ retransmissions and adaptive link adjustments.

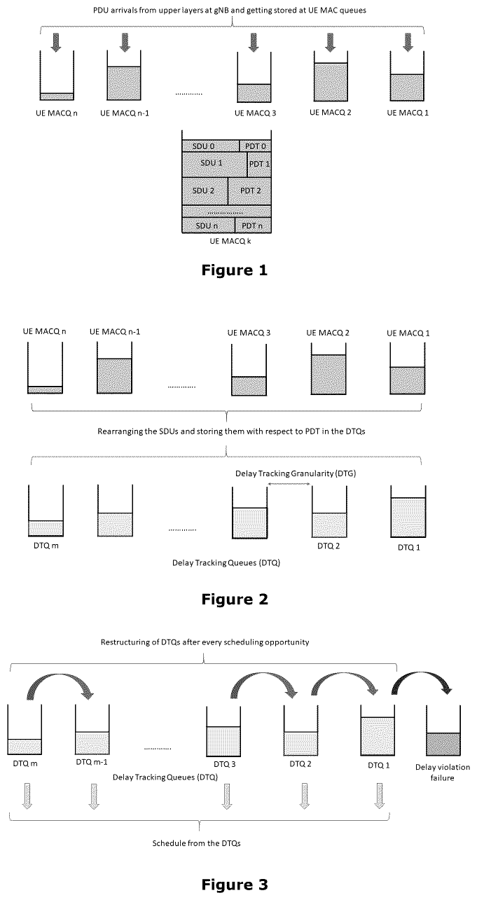

As depicted in FIG. 1, Protocol Data Units (PDUs) from the upper layers are stored in MAC queues (MACQ) at the gNB, with separate queues allocated for each User Equipment (UE). These queues not only store the SDUs but also track the corresponding PDCP discard timers (PDT) within the associated buffers. Each SDU is tagged with a unique UE ID, identifiable through the MAC address, ensuring accurate and efficient scheduling decisions.

We now present the proposed delay tracking mechanism.

### (A) Delay Tracking Mechanism:

To effectively monitor and manage transmission delays, two key concepts are introduced: Delay Tracking Queues (DTQs) and Delay Tracking Granularity (DTG). The Service Data Units (SDUs) stored in the MAC queues are reorganized and allocated into DTQs, as illustrated in FIG. 2. Each DTQ, designated as ‘DTQ x’, holds SDUs whose PDCP discard timers are set to expire within ‘x’ units of time. This means that SDUs in ‘DTQ x’ must be scheduled for transmission within ‘x’ time units; otherwise, they will incur a delay violation.

The granularity of these time units, referred to as Delay Tracking Granularity (DTG), is synchronized with the Transmission Time Interval (TTI) duration, which varies according to the numerology in use. For example, with numerology 0, the TTI duration is 1 ms, while numerology 1 corresponds to a TTI of 0.5 ms. Therefore, the DTG is equivalent to the duration of each TTI, ensuring precise and consistent tracking of delay across different numerology settings.

The delay tracking mechanism functions by partially or fully scheduling SDUs from each DTQ during every scheduling instance. As illustrated in FIG. 3, if only a portion of the SDUs within a DTQ is scheduled, the remaining SDUs will have their PDCP Discard Timer (PDT) reduced by one-time unit. For instance, if DTQ ‘m’ is only partially scheduled, the unscheduled SDUs in DTQ ‘m’ will have their PDT reduced to ‘m-1’ time units. These SDUs are then shifted to DTQ ‘m-1’ accordingly. This shifting process is repeated across all DTQs, ensuring that SDUs are continually moved to the appropriate DTQ based on their updated PDTs.

If any SDUs remain in DTQ 1 after a scheduling attempt, they are considered to have a PDT of zero, signalling a delay violation. These SDUs are subsequently discarded, as they have failed to meet the delay requirement. This systematic approach ensures that only SDUs within their allowable delay bounds are retained for transmission, maintaining the integrity of the delay tracking process.

This method outlines the delay tracking mechanism in action, demonstrating how the introduction of DTQs, combined with strategic queue management and the systematic shifting of unscheduled data units, enables precise monitoring of residual delay budgets.

### (B) DL-Scheduling Using Delay Tracking Mechanism:

While delay tracking is crucial, sometimes it alone does not guarantee optimal performance. The tracked delay information must be effectively integrated into the scheduling process to enhance overall system efficiency. The following sections describe a scheduling method that leverages the DTQ structure to maximize the number of XR users who meet their delay reliability requirements.

The proposed scheduling approach redefines the scheduling process as an optimization problem, utilizing Model Predictive Control (MPC) to manage the dynamic and complex nature of resource allocation in 5G networks. The primary objective of this scheduling mechanism is to maximize the number of XR users who achieve their specified delay reliability. Each user has a predefined delay reliability requirement, expressed as a percentage, which dictates the proportion of SDUs that must be successfully transmitted within the designated delay bound to satisfy the user's quality expectations.

The decision variables in this optimization problem are the resource blocks (RBs) allocated to each user. The optimization process adheres to a set of rules that govern the allocation of these resources, ensuring that the system meets the delay reliability targets for the maximum number of XR users.
1. SDU Enqueueing and Rearrangement: Initially, Service Data Units (SDUs) are enqueued in the MAC queues (MACQs) for each user at the gNB. These SDUs are then rearranged into Delay Tracking Queues (DTQs) based on their PDCP Discard Timers (PDT), as previously described.
2. DTQ Updates: The DTQs are updated according to the established procedures, where unscheduled SDUs are shifted between DTQs based on their remaining PDTs, ensuring accurate tracking of delay.
3. System Capacity: During each scheduling opportunity, the total resources allocated across all users must remain within the system's overall capacity, preventing overload and ensuring efficient resource utilization.
4. Queue Size Constraint: The amount of data served from each DTQ during scheduling is limited by the current size of that DTQ, ensuring that no more data is scheduled than is available in the queue.

Mathematically, this problem is formulated as a Mixed Integer Linear Program (MILP), known for its computational intractability due to the exponential complexity, particularly over an infinite time horizon. Solving such a problem also involves making assumptions about future traffic arrivals and channel conditions, which complicates its practicality for real-time applications. To overcome these challenges, we introduce a Model Predictive Control (MPC) based approach.

MPC is an advanced optimization-based control strategy that predicts future system behaviour using a dynamic model. At each time step, MPC solves an optimization problem over a finite prediction horizon, generating a sequence of control actions that minimize a cost function while adhering to system constraints. Only the first control action from the computed sequence is implemented, with the process repeated at each subsequent time step using updated system measurements, forming a receding horizon approach. MPC's ability to manage multivariable systems with constraints and adapt to changing conditions makes it well-suited for optimizing resource allocation in dynamic network environments.

We adapt MPC principles to the resource allocation problem, focusing on maximizing the number of XR users who meet their delay reliability requirements. The scheduling scheme uses a prediction horizon (H) to forecast and calculate future resource needs. The system state is represented by the DTQ information, which includes queue sizes and associated PDTs, with system dynamics influenced by new data arrivals, varying channel conditions, and scheduling decisions made at each instance.

At each time step (t), the scheme solves an optimization problem aimed at maximizing the number of users who meet their delay reliability targets while ensuring efficient resource allocation. The optimization considers the following constraints: (a) The total allocated resources must not exceed the system capacity, (b) Scheduling must respect each user's delay bounds as defined by their DTQ states, and (c) The scheme strives to satisfy the specified delay reliability percentages for each user.

The optimization process is conducted over the prediction horizon (H), but only the first step of the decisions (i.e., the resource block allocation for the current time step) is executed. After each time step, the system state is updated with new data, including the current state of the DTQs and the actual achieved delay reliability, after which the optimization is repeated with this updated state.

This method dynamically adapts to changing network conditions via a Compute Priorities submodule, which adjusts user priorities based on their current performance relative to their delay reliability targets. This adjustment ensures that users who are falling behind in meeting their targets receive higher priority in subsequent scheduling decisions, optimizing overall system performance.

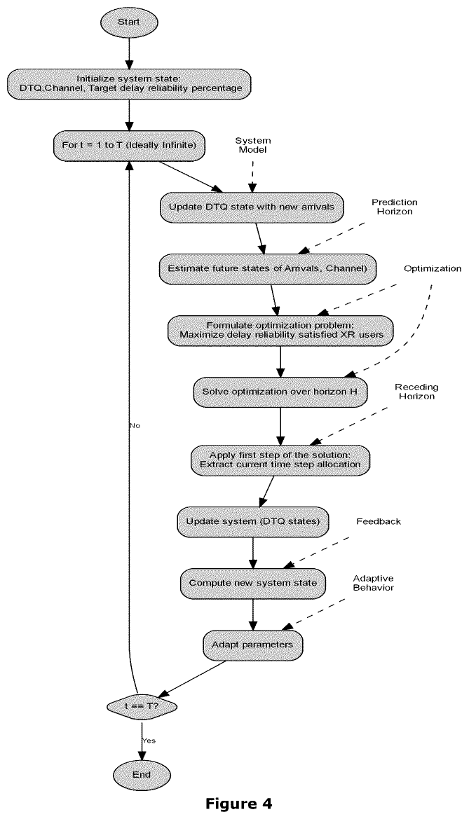

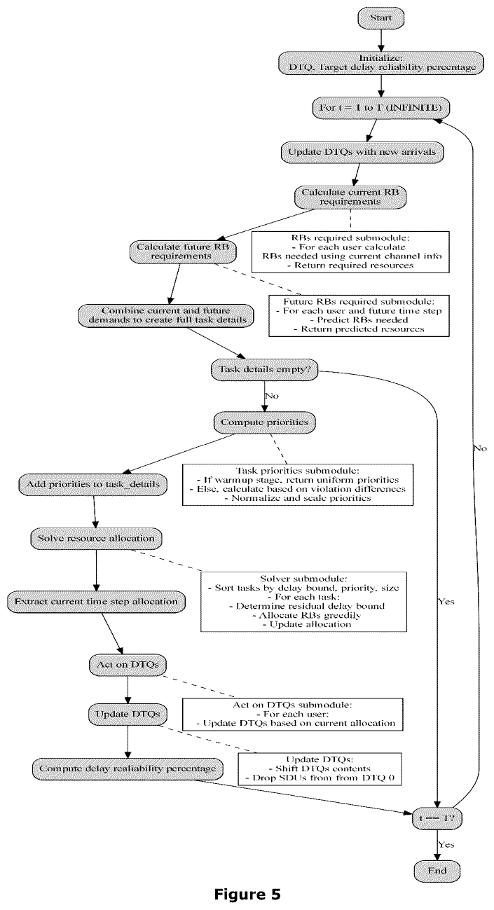

This approach enables the scheduling method to make informed decisions that effectively balance immediate resource allocation needs with anticipated future demands. By continuously adapting to new information and evolving network conditions, the method optimizes resource allocation within the dynamic 5G network environment, significantly enhancing overall delay reliability for XR users. This adaptive strategy ensures that the system remains responsive to real-time fluctuations while meeting the stringent requirements of XR applications. The flowchart of the method is illustrated in FIG. 4.

We now describe proposed heuristic method that is applied to solve the optimization at each time instant for RB allocation to the users, targeting the efficient satisfaction of delay reliability requirements for XR users. The method processes key input components, including:
1. DTQ State Information: Represents the current state of SDUs queued for each user along with their associated PDCP Discard Timer (PDT).
2. Channel Conditions Information: Provides real-time data on the network's channel conditions.
3. Target Delay Reliability Vector: Specifies the required percentage of SDUs that must be delivered within their delay bounds for each user.

Operational Workflow: At each discrete time step, the heuristic method performs the following operations:
1. DTQ Update: The heuristic method begins by updating the DTQs with new SDU arrivals. This ensures the system has the latest information on queued data and associated delay constraints.
2. Resource Requirement Calculation: The heuristic method calculates resource requirements through two submodules:
   Current DTQ State Analysis: Determines the resources needed to serve the current DTQ state.
   Future Resource Prediction: Predicts the resources required for anticipated SDU arrivals within a defined prediction horizon HHH. This prediction uses simple methods based on the assumption that channel conditions remain constant over the horizon and that SDU arrivals follow existing statistical models of XR traffic.

These submodules generate arrays containing user IDs, delay bounds, and required resource blocks, providing a comprehensive view of both immediate and forecasted network demands.

Adaptive Priority Computation: A distinguishing feature of this heuristic is its adaptive priority computation mechanism. During the initial steps (referred to as “warm-up steps”), the scheme assigns uniform priorities to all users to ensure equitable initial resource distribution. As the time progresses, the priority computation evolves based on the discrepancy between the achieved and target delay violation percentages. This dynamic adjustment allows the scheme to respond to changing network conditions and user performance, assigning higher priorities to users whose delay violations exceed their targets and lower priorities to those meeting or falling below their violation thresholds.

Task Allocation Process: The core task allocation process of the heuristic employs a greedy approach, which operates as follows:
1. Task Sorting: Tasks are sorted by their delay bounds, priorities, and sizes, with those having the shortest delay bounds and highest priorities being ranked highest.
2. Resource Allocation: The scheme allocates resources starting with the most critical tasks. For each task, it identifies available time slots within the delay bound and allocates resources greedily, filling each time slot (TTI) up to the system's capacity. If a task cannot be fully served within its delay bound, it is not allocated any resources, ensuring that no resources are wasted on data that would inevitably violate their delay constraints.

Queue State Management: Post resource allocation, the scheme manages the queue states through two key operations:
1. Application of Allocation Solution: The scheme reduces DTQ sizes based on the data served during the current time step.
2. DTQ Data Shifting: Unserved data units in each DTQ is shifted to the subsequent DTQ (i.e., from DTQ m to DTQ m-1), as previously described. Data remaining in DTQ 0 is considered to have violated its delay bound and is consequently discarded, contributing to the user's delay violation percentage.

Performance Metrics Update: The heuristic method continuously updates performance metrics, particularly the achieved delay reliability percentage for each user. This metric is essential for recalculating priorities in subsequent time steps, allowing the heuristic method to refine its resource allocation strategy based on historical performance data.

This heuristic method provides an effective balance between current network demands and future predictions. By dynamically prioritizing tasks, adaptively managing resources, and continuously updating performance metrics, the method aims to maximize the number of XR users who achieve their delay reliability requirements in 5G New Radio (NR) environments.

### Performance Evaluation:

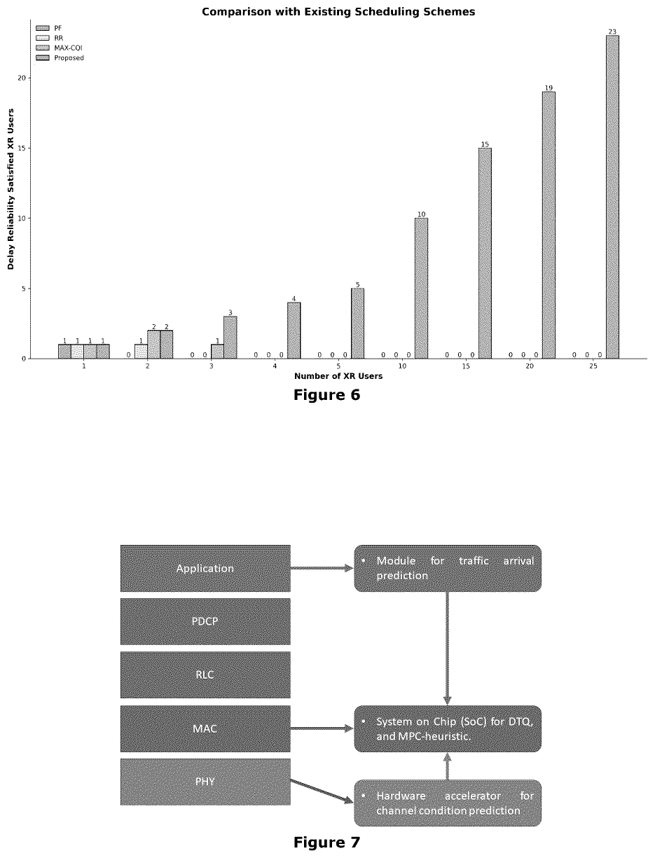

The proposed approach aims to balance the competing demands of different users while maximizing network efficiency. By considering both current DTQ states and predicted future arrivals, along with user-specific QoS requirements, the method provides significant improved performance compared to traditional scheduling methods such as Proportional Fair (PF), Round Robin (RR), and Maximum CQI (MAX-CQI). The following plot (FIG. 6) shows the performance gain in terms of number of delay reliability satisfied XR user for data rate of 30 Mbps, frame rate of 60 fps with delay bound of 5 ms and delay reliability of 95%. This result is obtained through custom simulation using python following standard 3GPP standard values of all necessary parameters.

### Hardware Modifications:

We now outline the necessary hardware modifications to the gNB and XR UE to facilitate the proposed scheduling method and associated features. These changes aim to enhance processing capabilities, optimize resource allocation, and improve the overall performance of the 5G network.

### gNB Modifications:

Enhanced MAC Layer Processor: The MAC layer of the gNB requires significant enhancements to support the implementation of Delay Tracking Queues (DTQs), dynamic queue management, and the proposed heuristic method for resource allocation. This can be achieved through the following:
   Custom ASIC or FPGA Implementation: Integrate the DTQ management, Model Predictive Control (MPC) method, and priority computation into a single Application-Specific Integrated Circuit (ASIC) or Field-Programmable Gate Array (FPGA). This integration is optimized for low power consumption while delivering high-performance processing, ensuring real-time execution of the scheduling scheme with minimal latency.
Predictive Processing Server: A dedicated hardware accelerator is needed to enhance the predictive capabilities of the gNB, crucial for the effective functioning of the heuristic. This unit will consist of:
   Channel Condition Prediction Module: A specialized hardware module designed to predict channel conditions based on current and historical data.
   Traffic Arrival Prediction Module: This module will utilize XR-specific statistical models to predict traffic arrival patterns and adjust scheduling strategies in anticipation of future network demands.

### UE Modifications:

Enhanced Receiver: The UE must be equipped with an advanced receiver capable of decoding more frequent Downlink Control Information (DCI). This enhancement is critical for:
   Faster Processing of Variable-sized Resource Allocations: The receiver will be optimized to handle the increased complexity and variability in resource allocation decisions, enabling the UE to quickly and efficiently process the dynamic scheduling information provided by the gNB.

This is described conceptually for both gNB and UE in FIG. 7.

Advantages: The described invention offers several advantages over existing methods, including improved delay reliability for XR users through precise delay tracking and adaptive scheduling. The use of DTQs ensures timely transmission of data units, while the integration of Model Predictive Control (MPC) and adaptive priority computation optimizes resource allocation in real-time, accommodating fluctuating network conditions. This leads to enhanced overall network efficiency, reduced delay reliability violations, and a superior user experience compared to traditional scheduling methods.

We claim:

1. A method for optimizing downlink scheduling in a 5G network to maximize number of XR (Extended Reality) users meeting their delay reliability requirements, comprising:
involving a number of XR user and assigning each of the XR users a predefined delay bound and a specified reliability threshold indicating minimum percentage of Service Data Units (SDUs) that must be successfully delivered within the delay bound;
implementing delay tracking to ensure that only the SDUs within their allowable delay bounds are retained and scheduled for transmission, maintaining the integrity of the delay tracking process;
employing a Model Predictive Control (MPC) approach to optimize resource allocation, forecasting future resource requirements and accordingly dynamically adjusting the scheduling decisions to maximize the number of the involved XR meeting their delay reliability requirements.

2. The method as claimed in claim 1, wherein the delay tracking includes
Delay Tracking Queues (DTQs) whereby the SDUs stored in MAC queues are reorganized and allocated into the DTQs, where each DTQ, designated as ‘DTQ x’, holds the SDUs whose Packet Data Convergence Protocol (PDCP) discard timers are set to expire within ‘x’ units of time such as that the SDUs in the DTQ x are scheduled for transmission within ‘x’ time units to avoid a delay violation; and
Delay Tracking Granularity (DTG) corresponds to granularity of the time units which is synchronized with Transmission Time Interval (TTI) duration to ensure precise and consistent tracking of delay across different numerology settings.

3. The method as claimed in claim 1, wherein the delay tracking includes partially or fully scheduling the SDUs from each of the DTQs during every scheduling instance, whereby if only a portion of the SDUs within a DTQ is scheduled, remaining SDUs PDCP Discard Timer (PDT) are reduced by one-time unit;
shifting the unscheduled SDUs between the DTQs based on updated PDTs;
repeating the shifting process across all the DTQs, ensuring that the SDUs are continually moved to the appropriate DTQ with lower priority based on their updated PDTs;
discarding the SDUs which are remain in same DTQ after a scheduling attempt for having a PDT of zero, signalling a delay violation and failing to meet the delay requirement to ensures that only the SDUs within their allowable delay bounds are retained for transmission, maintaining the integrity of the delay tracking process.

4. The method as claimed in claim 1, wherein the Model Predictive Control (MPC) method predicts future system behaviour using a dynamic model, whereby at each time step, the MPC solves an optimization problem over a finite prediction horizon, generating a sequence of control actions that minimize a cost function while adhering to system constraints focusing on maximizing the number of XR users who meet their delay reliability requirements including
generating the sequence of control action for the scheduling scheme using a prediction horizon (H) to forecast and calculate future resource needs, where system state is represented by the DTQ information, which includes queue sizes and associated PDTs, with system dynamics influenced by new data arrivals, varying channel conditions, and scheduling decisions made at each instance;
wherein at each time step (t), the scheme solves an optimization problem aimed at maximizing the number of users who meet their delay reliability targets while ensuring efficient resource allocation considering constraints: (a) total allocated resources must not exceed the system capacity, (b) scheduling must respect each user's delay bounds as defined by their DTQ states, and (c) scheme strives to satisfy the specified delay reliability percentages for each user.

5. The method as claimed in claim 4, wherein the MPC method includes heuristic method that is applied to solve the optimization at each time instant for resource block (RB) allocation to the users, targeting the efficient satisfaction of delay reliability requirements for XR users for resource allocation in a 5G network to meet XR users'delay reliability requirements, comprising:
receiving the Delay Tracking Queue (DTQ) information representing the current state of the SDUs and their PDCP Discard Timers (PDT);
calculating the resource requirements for each user based on the current DTQ state and predicted traffic arrivals using statistical models;
performing adaptive priority computation to dynamically adjust resource allocation priorities based on the user's delay performance;
allocating resources using a greedy approach that prioritizes tasks with the shortest delay bounds and highest priority, and ensuring no resources are wasted on tasks that cannot meet their delay bound.

6. The method as claimed in claim 1, wherein the future resource requirements are predicted based on statistical models that account for anticipated XR traffic arrivals and network channel conditions over a predefined prediction horizon.

7. A system for optimizing downlink scheduling in a 5G network to maximize the number of XR users meeting their delay reliability requirements involving the method as claimed in claim 1, comprising:
a processor configured to execute the delay tracking mechanism and scheduling optimization based on delay reliability requirements of XR users;
a memory storing Delay Tracking Queues (DTQs) containing SDUs and associated PDCP Discard Timers (PDT);
a communication module configured to allocate downlink resources to users in real time, based on an optimization strategy that maximizes delay reliability.

8. The system as claimed in claim 7, further comprising:
a user equipment (UE) configured to receive downlink control information (DCI) and process allocated resource blocks;
a gNB with a server configured to execute the Model Predictive Control (MPC) based optimization for allocating resources to maximize the number of the XR users who meet their delay reliability targets, based on delay tracking and priority computation.
